(19) United States
(12) Patent Application Publication
(10) Pub. No.: US 2011/0032561 A1
(43) Pub. Date: Feb. 10, 2011

(54) Universal Printer Chip With A Single Data Table

(76) Inventors: Joseph M. Cachia, Las Vegas, NV (US); Ken Segler, North Las Vegas, NV (US)

Correspondence Address: MARC E. HANKIN, ESQ., 11414 THURSTON CIRCLE, LOS ANGELES, CA, 90049, US

(21) Appl. No.: 12/535,629

(22) Filed: Aug. 4, 2009

(51) Int. Cl. G06K 1/00

(52) U.S. Cl. 358/1.15

(57) ABSTRACT

The invention is a replacement universal printer chip that utilizes a single data table. The replacement printer chip includes a microcontroller that emulates the chip functions of an entire model line of printers made by the same manufacturer. The universal chip identifies and blocks the overwrite locations in a single data table of multiple models of printers made by the same manufacturer. The single data table chip functions correctly on all machine or printer models of a particular manufacturer.

### BACKGROUND OF THE INVENTION

This invention relates to universal printer chips, and more specifically a universal printer chip with a single data table.

Currently, most imaging machines, such as printers, copiers, faxes and multi-function machines, utilize user-replaceable cartridges that contain the printing media, usually dry ink, also known as toner, or liquid ink. The user obtains a replacement cartridge to replenish the toner or ink supply to continue to print good quality documents and images when the prior cartridge has been depleted. When cartridges were first introduced into the market, they were initially seen as office trash and were discarded after the ink or toner supply was depleted. However, the cartridges were generally very durable and capable of being refilled with an additional ink or toner supply. Due to the considerable waste that was generated by all of the discarded cartridges, and the expense of manufacturing all new cartridges each time the present cartridge ran out of ink or toner, an industry developed to collect the spent cartridges and refill, or even remanufacture them to a like-new condition.

Typically, spent cartridges that are remanufactured are disassembled, cleaned, have any damaged parts replaced, and the toner or ink supply is replenished. In recent years, however, the original equipment manufacturers (“OEM”) have started to equip the cartridges with a small circuit board or chip. These chips are programmed or written with data that is specific for the particular type or model of machine with which the cartridge is intended to be used. The general purpose of the chips is to: 1) allow the printing machine to verify that the cartridge installed is the correct cartridge for that machine by ‘reading’ the data on the chip; if the data is correct, the machine accepts the cartridge and allows use of the cartridge; but if the data is incorrect, or if the machine cannot read the chip, the cartridge is rejected and no printing is allowed; and 2) allow the machine to record information relevant to the cartridge, such as printer serial number, pages printed, toner remaining, etc., onto the chip.

When the toner in the cartridge is depleted, the machine usually ‘closes’ the chip from further use. The machine is alerted to the toner depletion through sensors or through counting down the total number of pages printed out by the machine with that cartridge. Once the cartridge is closed, it cannot be reused, even after refilling or remanufacturing, unless a replacement chip is installed. Without a replacement chip, the machine still reads the old chip, which tells the machine that the refurbished cartridge is in a ‘toner low’ or ‘toner out’ condition, and printing is not allowed.

In order to provide a fully functioning remanufactured replacement cartridge, the remanufacturer must provide a replacement chip. The replacement chips, by design, must emulate the fit and function of the OEM chip to provide error-free usage. These replacement, or aftermarket, chips have been developed by a number of different companies.

The resource capabilities of the OEMs enabled the OEMs to release numerous printer models and versions, often using existing chip hardware, but programmed with different data (software) that corresponded to a specific hardware model. Aftermarket solutions initially provided a direct, one-for-one replacement product for each printer model type. In other words, the remanufacturers would refurbish the replacement cartridge with a dedicated chip that would work only on one model of machine. More recently, some aftermarket solutions have been creative in providing a “universal” chip, which is a chip capable of operating on different models, without the need to specify a dedicated printer version or model.

One approach, previously used, has been to utilize a compatible aftermarket chip containing multiple data tables within the memory. Each data table is specific for a corresponding printer model. This type of aftermarket universal chip receives the printer or other machine's communications at initialization, determines the specific model of machine that is reading the chip, and through programming, typically firmware, selects the corresponding data table for that model, thus ensuring proper operation.

However, some printer or machine models determine if a chip is acceptable by sending a write command to a specific location in the OEM chip data table. The data table contains information at that location, which is specific to the particular printer model. The write command may also attempt to overwrite the original data in the data table with bad data. If the chip is an OEM chip, the OEM logic blocks the overwrite, but if the chip is a replacement chip, the data may be overwritten. If the data is overwritten, and then read back, the bad data informs the machine that the chip is not an OEM chip and an error is triggered. The machine will not use the replacement cartridge. To compensate for this, many aftermarket replacement chips utilize microcontrollers to emulate OEM chip functions. The aftermarket replacement chip microcontroller is programmed to block any writes to the specific location in the data table, in the case of a dedicated chip, or the data tables, in the case of a universal chip. This allows the printer to read the original data and, thus, the replacement chip and cartridge is able to function.

By analysis, it has been determined that different printer models in a line of printer models attempt to overwrite different locations on the data tables, importantly, these locations do not overlap, and the models do not evaluate the data tables for data in other locations. Moreover, through continued evaluation, the specific write locations identifying the chip to the model have been identified. Thus, by programming the replacement chip microcontroller to block each location on the data tables that may be potentially overwritten by a particular printer model, the printer reads correct data, and allows the replacement chip to function in a number of different machine models. Currently, the microcontrollers of replacement universal chips utilize multiple data tables, typically one data table per compatible model, and the microcontroller is programmed to block specific locations on each data table, depending on which model corresponds to which data table.

There are several references that disclose aftermarket universal chips with separate data tables as described above. Specifically, U.S. Pat. No. 7,088,928, issued to Burchette et al., and U.S. Pat. No. 7,254,346, issued to Lynton et al., disclose various types of universal chips, and U.S. Pat. No. 7,356,279, issued to Miller (“Miller I”), U.S. Pat. No. 7,187,874, issued to Miller, and U.S. Pat. No. 7,257,335, issued to Chan, all disclose various types of aftermarket universal chips with microcontrollers that emulate OEM chip functions. However, none of these references discloses an aftermarket universal chip that utilizes a single data table for all machine or printer models for which the chip will communicate with or is compatible. Indeed, Miller I explicitly teaches away from a single data table. As described in col. 5, lines 5-68 to col. 6, lines 1-68, Miller I indicates that a memory table must be established for each printer model that is to be identified by the microcontroller.

Thus, what is needed is an aftermarket or replacement universal printer chip that utilizes a single data table. Preferably the replacement printer chip includes a microcontroller that emulates the chip functions of an entire model line of printers made by the same manufacturer.

### SUMMARY OF THE INVENTION

Various embodiments of the invention are directed towards overcoming the above deficiencies of the prior art by providing a replacement printer chip that utilizes a single data table. Preferably the replacement printer chip includes a microcontroller that emulates the chip functions of an entire model line of printers made by the same manufacturer. By identifying and blocking the overwrite locations in a single data table for multiple different models of printers made by the same manufacturer, the single data table chip can function correctly on all machine or printer models of a particular manufacturer. The invention disclosed eliminates the need to inventory multiple chip type variations for a particular manufacturer.

This invention is specifically different from other universal chip types, because typically, those universal chip types require the chip microcontroller to process printer communications and make selections from different data tables. The pre-determined locations are instead provided in a single data table, which provides all of the information required, and renders the chip to be universal for the various models. Typically, these various models are all in the same product line made by a single manufacturer.

One embodiment of the present invention is a universal printer cartridge chip comprising: a single data table. The universal printer cartridge chip fits within a chip cavity of a plurality of printer cartridges. Each of the printer cartridges fits matingly with at least one of a plurality of printer models. The universal printer cartridge chip enables interoperation between each of the different types of printer cartridges and at least one of the printer models. The single data table has a plurality of data that is organized in a plurality of discrete data locations. Each of the discrete data locations is associated with at least one of the printer models. The printer models are preferably different models all made by the same manufacturer. Preferably, the data in the single data table enables the universal cartridge chip to communicate with each and every printer model type made by a single manufacturer. Preferably, the universal printer cartridge chip further comprises a microcontroller. The microcontroller of the chip enables interoperation between each of the printer cartridges and at least one of the printer models. The microcontroller receives a plurality of communications from the printer models and directs the printer models and communications received from the printer models to the single data table to enable proper interoperation between the universal printer cartridge chip and all of printer models. The single data table has a plurality of overwrite locations and each of these overwrite locations corresponds to one of the printer models. The microcontroller identifies and blocks the overwrite locations from being overwritten by the printer models.

Another embodiment of the invention is a universal printer cartridge chip comprising: a single data table; microcontroller, and appropriate circuit to support microcontroller function. The universal printer cartridge chip fits within a chip cavity of a plurality of printer cartridges. The printer cartridges fit matingly with at least one of the printer models. The microcontroller enables interoperation between each of the printer cartridges and at least one of the printer models. The single data table has a plurality of data organized in a plurality of discrete data locations. Each of the discrete data locations is associated with at least one of the printer models. The microcontroller receives a plurality of communications from the printer models and directs printer models and communications received from the printer models to the single data table to enable proper interoperation between the universal printer cartridge chip and each and every one of the printer models. The single data table has a plurality of overwrite locations and the overwrite locations correspond to a specific printer model. The microcontroller identifies and blocks the overwrite locations from being overwritten by the printer models. The printer models are preferably all different models of printers made by the same manufacturer. The data of the single data table enables the universal cartridge chip to communicate with all of the printer models made by the single manufacturer.

Another embodiment of the invention is a method of enabling interoperation between a universal printer cartridge chip and a plurality of printer models comprising the steps of: providing a universal printer cartridge chip, the universal printer cartridge chip having a single data table; providing a plurality of printer cartridges, wherein the universal printer cartridge chip fits within a chip cavity of a plurality of printer cartridges, and wherein each of the plurality of printer cartridges fits matingly with at least one of a plurality of printer models; fixing the universal printer cartridge chip within the chip cavity of at least one of the plurality of printer cartridges; inserting one of the plurality of printer cartridges into an appropriate corresponding printer model; determining by the universal printer cartridge chip via the single data table which printer model the inserted printer cartridge is in; and communicating in a correct manner by the universal printer cartridge chip with the appropriate corresponding printer model to enable interoperation between the inserted printer cartridge and the appropriate corresponding printer models. Preferably the method further comprises the step of providing a universal printer chip that further comprises a microcontroller; wherein the microcontroller enables interoperation between each of the plurality of printer cartridges and at least one of the plurality of printer models; wherein the single data table has a plurality of data organized in a plurality of discrete data locations; wherein each of the plurality of discrete data locations is associated with at least one of the plurality of printer models; receiving by the microcontroller of a plurality of communications received from the plurality of printer models; and directing by the microcontroller the plurality of received communications to the single data table to enable proper interoperation between the universal printer cartridge chip and the plurality of printer models. Additionally, the steps may also include providing a plurality of overwrite locations within the single data table; corresponding the plurality of overwrite locations to the plurality of printer models; identifying by the microcontroller the plurality of overwrite locations; and blocking by the microcontroller the plurality of overwrite locations from being overwritten by the plurality of printer models. Preferably the universal printer cartridge chip enables the plurality of printer cartridges to interoperate with the plurality of printer models when each of the plurality of printer cartridges is inserted into the appropriate corresponding printer model. Finally, the plurality of printer models are all made by a single manufacturer, and wherein the plurality of data of the single data table enables the universal cartridge chip to communicate with all of the plurality of printer models made by the single manufacturer.

An object of the present invention is to provide a universal chip that overcomes the limitations of the prior art.

Another object of the present invention is to provide a universal chip that can be attached to various remanufactured printer cartridges that are physically compatible with any and all printer models made by a particular manufacturer.

Another object of the present invention is to provide a universal chip that has a single data table and wherein that single data table includes information that corresponds to any and all models of printers made by a particular manufacturer.

Another object of the present invention is to provide a universal chip with a microcontroller and a single data table that provides all of the information needed to allow the chip to communicate with all of the printer models made by the same manufacturer. The microcontroller prevents the single data table from being overwritten by any of the printer models.

Other features and advantages are inherent in the universal chip with a single data table claimed and disclosed will become apparent to those skilled in the art from the following detailed description and its accompanying drawings.

### BRIEF DESCRIPTION OF THE DRAWINGS

FIG. 1 is a block diagram representing how one embodiment of the invention is compatible with a plurality of printer cartridges.

FIG. 2 is a block diagram representing how one embodiment of the invention enables printer cartridges with the universal chip invention to communicate and interoperate with all printer makes and models of a single manufacturer.

FIG. 3 is a block diagram representing how one embodiment of the invention includes a microcontroller that receives communications from the printer models and directs the printer models and any communications received from the printer models to the single data table to enable proper interoperation between the universal printer cartridge chip and the printer model.

FIG. 4 is a block diagram representing how the single data table of one embodiment of the invention has a plurality of overwrite locations and each of these overwrite locations corresponds to one of the printer models. FIG. 4 also shows how the invention identifies and blocks the overwrite locations from being overwritten by the printer models.

### DETAILED DESCRIPTION OF THE DRAWINGS

In the following detailed description of the various embodiments of the invention, numerous specific details are set forth in order to provide a thorough understanding of various embodiments of the invention. However, one or more embodiments of the invention may be practiced without these specific details. In other instances, well-known methods, procedures, and/or components have not been described in detail so as not to unnecessarily obscure aspects of embodiments of the invention.

In the following detailed description of the various embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention. Accordingly, the drawings and detailed description are to be regarded as illustrative in nature and not restrictive. In addition, the reference or non-reference to a particular embodiment of the invention shall not be interpreted to limit the scope of the invention.

In the following description, certain terminology is used to describe certain features of one or more embodiments of the invention. For instance “printer” refers to any image forming device that accepts the use of an ink or toner cartridge, including, but not limited to printers, copiers, facsimiles, or machines that combine printing, copying, and faxing. “Microcontroller” is any system, device, or execution unit with functionality capable of enabling the communications, compatibility, and interoperations described herein. The “microcontroller” is capable of storing information, receiving signals, including those signals received from an outside source, such as a printer, and transmitting signals. Preferably the “microcontroller” is a single integrated circuit. A “printer cartridge” is a replaceable ink or toner cartridge that is accepted into a “printer”

The first embodiment of this invention is a universal printer cartridge chip with a single data table. The universal printer cartridge chip is typically a replacement or aftermarket chip that can be used with multiple types of printer models. The invention is different than previous universal printer cartridge chips because the chip specifically has one, and only one data table, or memory data table. In the prior art, the universal printer cartridge chips require multiple data tables, typically, one data table per printer model with which the printer cartridge chip is compatible. The prior art universal printer cartridge chip determines which printer model the cartridge has been inserted into and directs any communications to the appropriate data table. The universal printer cartridge chip of the present invention only has one data table. The present invention determines which printer model the cartridge has been inserted into and then directs the communications to the single data table, which provides the necessary information to enable the printer to recognize the cartridge as appropriate.

Another embodiment of the invention is a universal printer cartridge chip with a single data table and a microcontroller. The microcontroller allows the present invention to overcome the additional security feedback communications received from certain models of printers. Frequently, printers are programmed to determine if the printer cartridge chip that is attached to the inserted printer cartridge is an OEM chip or an aftermarket chip. If the universal printer cartridge chip is not an OEM chip, or does not emulate an OEM chip, the printer communication, typically an initialization communication, may overwrite some of the data in the memory data table of the printer cartridge chip. The printer will then send a follow up communication to the overwrite locations and if those locations have been overwritten, the printer will reject the cartridge. To overcome this programming feedback disablement, the present invention includes a microcontroller that recognizes the overwrite communications from the printer and recognizes the model of printer that is sending the communication and blocks the appropriate data locations that the printer will attempt to overwrite. In this manner, the printer will continue to recognize the inserted cartridge and the cartridge and the printer will interoperate.

Preferably the universal printer cartridge chip of the present invention will communicate with and enable operation between any cartridges to which the chip is affixed and all makes and models of printers for a specific manufacturer. Although the universal printer cartridge chip of the present invention is not designed to work with different manufacturers, because each manufacturer typically includes different programming and communications that make it difficult to program a microcontroller for more than one manufacturer, it should be understood that a single universal printer cartridge chip of the present invention could work with printers made by different manufacturers.

Printer manufacturers sometimes make a line of printers wherein the different printers will have differently sized or shaped printer cartridge receiving slots. The present invention, so long as it can be adapted to affix to the printer cartridge, can specifically work with printer cartridges of various sizes. In other words, the printer cartridges do not have to be of the same size for the universal printer cartridge chip of the present invention to enable each and every single printer cartridge in a line of printer cartridges to interoperate with the corresponding printer model.

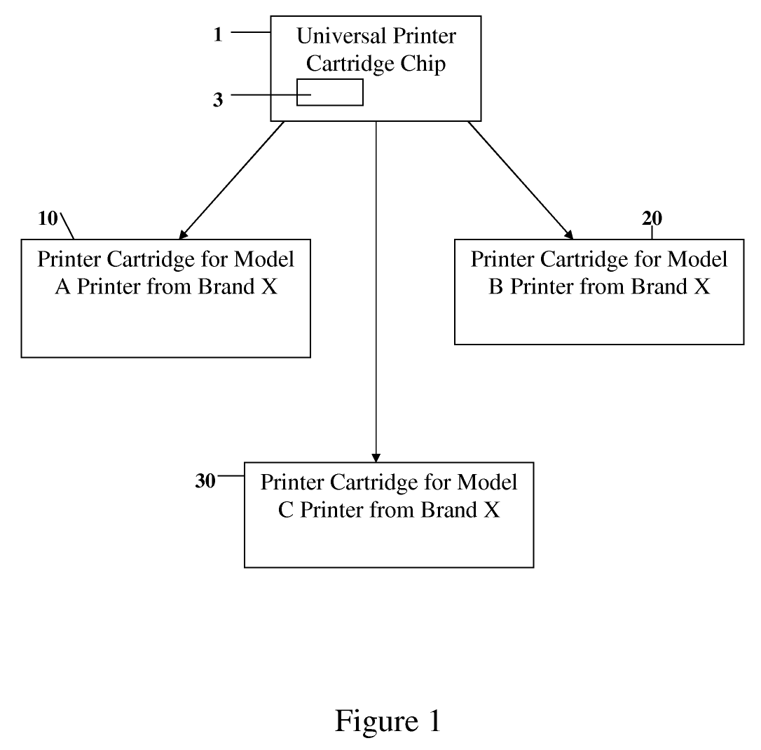

FIG. 1 is a block diagram representing how one embodiment of the invention is compatible with a plurality of printer cartridges. As shown in FIG. 1, the universal printer cartridge chip 1 includes a single data table 3. The chip 1 is designed to physically fit and be compatible with several different printer cartridges 10, 20, and 30. FIG. 1 shows how the chip 1 can be affixed to three different printer cartridges that are designed to be used with three different printer models from Brand X. Although chip 1 is only shown fitting with three different types of printer cartridges, it should be understood that chip 1 may be compatible with any number of printer cartridges. Additionally, chip 1 may be compatible with printer cartridges from more than one brand of printers.

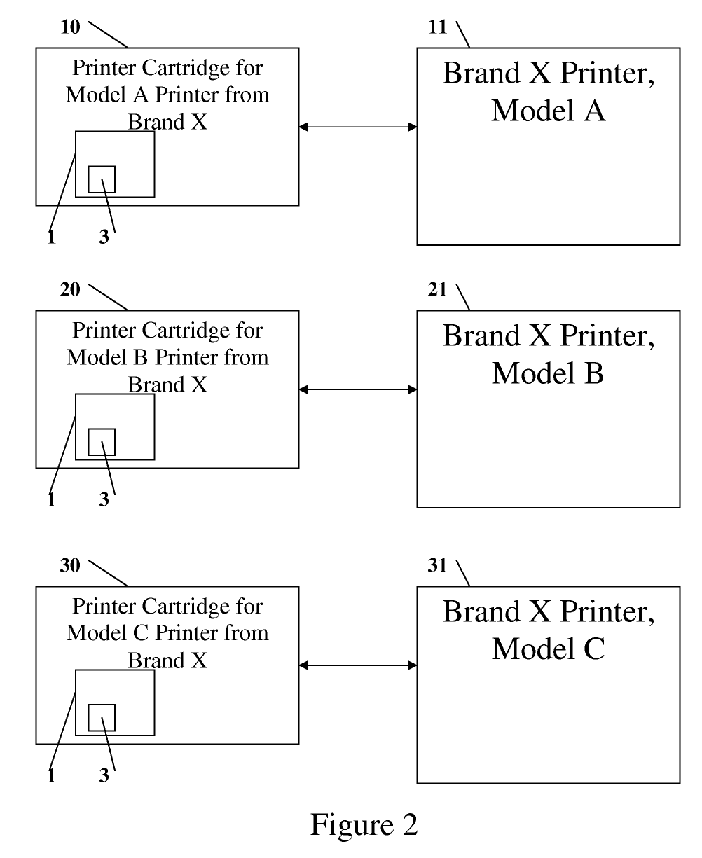

FIG. 2 is a block diagram representing how one embodiment of the invention enables printer cartridges with the universal chip invention to communicate and interoperate with all printer makes and models of a single manufacturer. As shown in FIG. 2, chip 1, which includes single data table 3 is designed to fit with several different printer cartridges 10, 20, and 30. FIG. 2 also shows how printer cartridges 10, 20, and 30 matingly fit with, interoperate, and communicate with Brand X Printer Model A 11, Brand X Printer Model B 21, and Brand X Printer Model C 31. Chip 1 enables each of the printer cartridges 10, 20, and 30 to interoperate and communicate with printers 11, 21, and 31. Although the printer cartridges 10, 20, and 30 are not shown in FIG. 2 as being able to cross operate, it should be known that depending on the physical compatibility of the printers and printer cartridges, such cross operation is possible with chip 1.

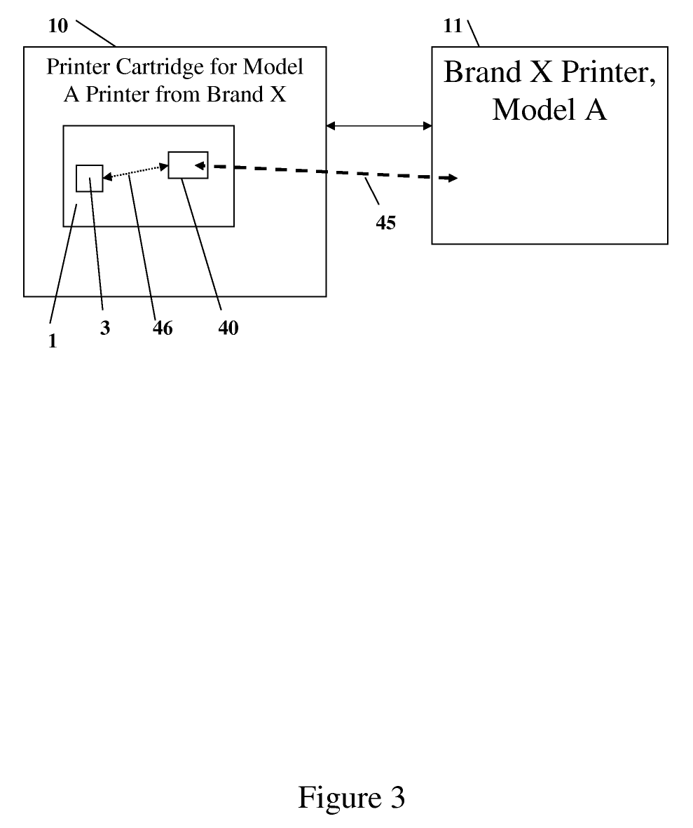

FIG. 3 is a block diagram representing how one embodiment of the invention includes a microcontroller that receives communications from the printer models and directs the printer models and any communications received from the printer models to the single data table to enable proper interoperation between the universal printer cartridge chip and the printer model. As shown in FIG. 3, printer cartridge 10 is inserted and into printer 11 and universal printer cartridge chip 1 communicates with printer 11. The communications 45 sent by printer 11 are received by microcontroller 40. Microcontroller 40 directs the communications 46 to single data table 3. Microcontroller 40 ensures proper interoperation between printer cartridge 10 and printer 11.

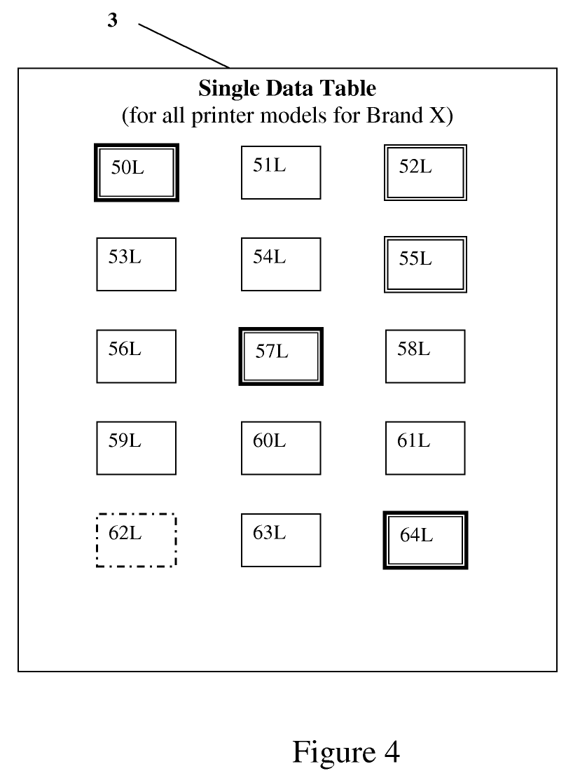

FIG. 4 is a block diagram representing how the single data table of one embodiment of the invention has a plurality of overwrite locations and each of these overwrite locations corresponds to one of the printer models. FIG. 4 also shows how the invention identifies and blocks the overwrite locations from being overwritten by the printer models. As shown in FIG. 4, single data table 3 preferably has a plurality of memory locations, referred to here as overwrite locations, including locations 50, 51, 52, 53, 54, 55, 56, 57, 58, 59, 60, 61, 62, 63, 64. FIG. 4 shows these locations with the identifier L, which stands for location. FIG. 4 also shows locations 50, 57, and 64 as similarly highlighted. Locations 50, 57, and 64, as an example, are overwrite locations for printer model A 11 (not shown in FIG. 4). When the printer cartridge A 10 (not shown in FIG. 4) is inserted into printer model A 11, printer model A sends a communication to chip 1, which includes single data table 3. The sent communication attempts to overwrite locations 50, 57, and 64. However, the microcontroller 40 (not shown in FIG. 4) identifies and blocks locations 50, 57, and 64 from being overwritten. This allows printer cartridge 10 to be recognized by and interoperate with printer 11.

FIG. 4 also shows how locations 52 and 55 may be identified and blocked as a set of overwrite locations and location 62 as being a single overwrite location. Although FIG. 4 shows that the printers may attempt to over write at one, two, or three, locations, it should be understood that the printers may overwrite, or attempt to overwrite, any number of locations in single data table 3. Importantly, FIG. 4 shows how single data table 3 includes all of the necessary information and overwrite locations for all printer models for a single and specific brand of printers. This allows chip 1 to be used across an entire printer product line that is offered by a manufacturer. This greatly reduces the number of different types of chips that an aftermarket printer cartridge manufacturer must inventory. As shown in FIG. 4, the overwrite locations that correspond to a specific printer model preferably do not overlap. This allows the microcontroller to more easily identify which locations to protect based on which printer is sending the communication.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope of the invention. It is intended that the scope of the invention not be limited by this detailed description, but by the claims and the equivalents to the claims that are appended hereto.

We claim:

1. A universal printer cartridge chip comprising:
a single data table;
wherein said universal printer cartridge chip fits within a chip cavity of a plurality of printer cartridges; and
wherein each of said plurality of printer cartridges fits matingly with at least one of a plurality of printer models and wherein said universal printer cartridge chip enables interoperation between each of said plurality of printer cartridges and at least one of said plurality of printer models.

2. The universal printer cartridge chip of claim 1, wherein said single data table has a plurality of data organized in a plurality of discrete data locations;
wherein each of said plurality of discrete data locations is associated with at least one of said plurality of printer models.

3. The universal printer cartridge chip of claim 2, wherein said plurality of printer models are all made by a single manufacturer, and wherein said plurality of data of said single data table enables said universal cartridge chip to communicate with all of said plurality of printer models made by said single manufacturer.

4. The universal printer cartridge chip of claim 1, further comprising:
a microcontroller;
wherein said microcontroller enables interoperation between each of said plurality of printer cartridges and at least one of said plurality of printer models.

5. The universal printer cartridge chip of claim 4, wherein said microcontroller receives a plurality of communications from said plurality of printer models, wherein said microcontroller directs said plurality of communications from said plurality of printer models to said single data table to enable proper interoperation between said universal printer cartridge chip and said plurality of printer models.

6. The universal printer cartridge chip of claim 5, wherein said single data table has a plurality of overwrite locations;
wherein said plurality of overwrite locations corresponds to said plurality of printer models; and
wherein said microcontroller identifies and blocks said plurality of overwrite locations from being overwritten by said plurality of printer models.

7. The universal printer cartridge chip of claim 3, further comprising:
a microcontroller;
wherein said microcontroller enables interoperation between each of said plurality of printer cartridges and at least one of said plurality of printer models;

8. The universal printer cartridge chip of claim 7, wherein said microcontroller receives a plurality of communications from said plurality of printer models, wherein said microcontroller directs said plurality of communications from said plurality of printer models to said single data table to enable proper interoperation between said universal printer cartridge chip and said plurality of printer models.

9. The universal printer cartridge chip of claim 8, wherein said single data table has a plurality of overwrite locations;
wherein said plurality of overwrite locations corresponds to said plurality of printer models; and
wherein said microcontroller identifies and blocks said plurality of overwrite locations from being overwritten by said plurality of printer models.

10. A universal printer cartridge chip comprising:
a single data table; and
a microcontroller;
wherein said universal printer cartridge chip fits within a chip cavity of a plurality of printer cartridges;
wherein each of said plurality of printer cartridges fits matingly with at least one of a plurality of printer models; and
wherein said microcontroller enables interoperation between each of said plurality of printer cartridges and at least one of said plurality of printer models.

11. The universal printer cartridge chip of claim 10, wherein said single data table has a plurality of data organized in a plurality of discrete data locations;
wherein each of said plurality of discrete data locations is associated with at least one of said plurality of printer models; and
wherein said microcontroller receives a plurality of communications from said plurality of printer models, wherein said microcontroller directs said plurality of communications from said plurality of printer models to said single data table to enable proper interoperation between said universal printer cartridge chip and said plurality of printer models.

12. The universal printer cartridge chip of claim 11, wherein said single data table has a plurality of overwrite locations;
wherein said plurality of overwrite locations corresponds to said plurality of printer models; and
wherein said microcontroller identifies and blocks said plurality of overwrite locations from being overwritten by said plurality of printer models.

13. The universal printer cartridge chip of claim 12, wherein said plurality of printer models are all made by a single manufacturer, and wherein said plurality of data of said single data table enables said universal cartridge chip to communicate with all of said plurality of printer models made by said single manufacturer.

14. A method of enabling interoperation between a universal printer cartridge chip and a plurality of printer models comprising the steps of:
providing a universal printer cartridge chip, said universal printer cartridge chip having a single data table;
providing a plurality of printer cartridges, wherein said universal printer cartridge chip fits within a chip cavity of a plurality of printer cartridges, and wherein each of said plurality of printer cartridges fits matingly with at least one of a plurality of printer models;
fixing said universal printer cartridge chip within said chip cavity of at least one of said plurality of printer cartridges;
inserting one of said plurality of printer cartridges into an appropriate corresponding printer model;
determining by said universal printer cartridge chip via said single data table which printer model said inserted printer cartridge is in; and
communicating in a correct manner by said universal printer cartridge chip with said appropriate corresponding printer model to enable interoperation between said inserted printer cartridge and said appropriate corresponding printer models.

15. A method of enabling interoperation between a universal printer cartridge chip and a plurality of printer models of claim 14, wherein said universal printer cartridge chip enables said plurality of printer cartridges to interoperate with said plurality of printer models when each of said plurality of printer cartridges is inserted into said appropriate corresponding printer model.

16. A method of enabling interoperation between a universal printer cartridge chip and a plurality of printer models of claim 15, wherein said plurality of printer models are all made by a single manufacturer, and wherein said plurality of data of said single data table enables said universal cartridge chip to communicate with all of said plurality of printer models made by said single manufacturer.

17. A method of enabling interoperation between a universal printer cartridge chip and a plurality of printer models of claim 14, further comprising the steps of:
providing a universal printer chip that further comprises a microcontroller;
wherein said microcontroller enables interoperation between each of said plurality of printer cartridges and at least one of said plurality of printer models;
wherein said single data table has a plurality of data organized in a plurality of discrete data locations;
wherein each of said plurality of discrete data locations is associated with at least one of said plurality of printer models;
receiving by said microcontroller of a plurality of communications received from said plurality of printer models; and
directing by said microcontroller said plurality of received communications to said single data table to enable proper interoperation between said universal printer cartridge chip and said plurality of printer models.

18. A method of enabling interoperation between a universal printer cartridge chip and a plurality of printer models of claim 17, further comprising the steps of:
providing a plurality of overwrite locations within said single data table;
corresponding said plurality of overwrite locations to said plurality of printer models;
identifying by said microcontroller said plurality of overwrite locations; and
blocking by said microcontroller said plurality of overwrite locations from being overwritten by said plurality of printer models.

19. A method of enabling interoperation between a universal printer cartridge chip and a plurality of printer models of claim 18, wherein said universal printer cartridge chip enables said plurality of printer cartridges to interoperate with said plurality of printer models when each of said plurality of printer cartridges is inserted into said appropriate corresponding printer model.

20. A method of enabling interoperation between a universal printer cartridge chip and a plurality of printer models of claim 19, wherein said plurality of printer models are all made by a single manufacturer, and wherein said plurality of data of said single data table enables said universal cartridge chip to communicate with all of said plurality of printer models made by said single manufacturer.
